(19) United States
(12) Patent Application Publication
(10) Pub. No.: US 2009/0083255 A1
(43) Pub. Date: Mar. 26, 2009

(54) Query spelling correction

(75) Inventor: Mu Li, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/903,591

(22) Filed: Sep. 24, 2007

(51) Int. Cl. G06F 17/30

(52) U.S. Cl. 707/5; 707/E17.108

(57) ABSTRACT

A technology for query spelling correction is disclosed. In one method approach, web search results generated based on a query term are received. The web search results are used as a part of determining a correction candidate for the query term if the query term is incorrectly spelt.

### RELATED APPLICATIONS

This Application is related to U.S. patent application Ser. No. 11/589,557 by Mu Li and Ming Zhou, filed on Oct. 30, 2006 and entitled “DISTRIBUTIONAL SIMILARITY-BASED MODELS FOR QUERY CORRECTION” with attorney docket no. 317147.01, assigned to the assignee of the present patent application the contents of which are incorporated herein.

### BACKGROUND

Web search engines have been developed that allow users to search for information on a network such as the Internet by submitting a query including of one or more query terms. For example, a user may enter a query into a data entry field of a web page associated with a web search engine. The web search engine can access the query and search the network for information that satisfies the query. Web search results that depict, among other things, one or more URLs to documents that satisfy the query are found by the web search engine and are displayed.

One obstacle to obtaining the proper web search results is that users often misspell the query terms associated with their query. To alleviate this problem, many web search engines check the spelling of the query terms and provide suggestions to the user for correcting the query.

Traditional research on spelling correction has relied on pre-defined lexicons for detecting spelling errors. However, this method does not work well for web query spelling correction since there is no lexicon that can cover the vast number of query terms that may be used for performing a web search.

The discussion above is merely provided for general background information and is not intended to be used as an aid in determining the scope of the claimed subject matter.

### SUMMARY

This Summary is provided to introduce concepts concerning query spelling correction which are further described below in the Detailed Description. This Summary is not intended to identify key features or essential features of the claimed subject matter, nor is it intended to be used as an aid in determining the scope of the claimed subject matter.

A technology for query spelling correction is disclosed. In one method approach, web search results generated based on a query term are received. The web search results are used as a part of determining a correction candidate for the query term if the query term is incorrectly spelt. For example, web search results that include the word “vacuum” may be used to determine that a query term “vaccum” is incorrectly spelt. The word “vacuum” from the web search results can be used as a correction candidate for the incorrectly spelt query term “vaccum.”

### DESCRIPTION OF THE DRAWINGS

The accompanying drawings, which are incorporated in and form a part of this specification, illustrate embodiments of the technology for query spelling correction and, together with the description, serve to explain principles discussed below:

FIGS. 1 and 2 depict parts of web search results, according to various embodiments.

FIG. 3 depicts equations, according to various embodiments.

FIG. 4 depicts a relationship between different configurations of a maximum entropy model based on different feature values, according to one embodiment.

FIG. 5 is a block diagram of a system for query spelling correction, according to one embodiment.

FIG. 6 is a flowchart of a method of query spelling correction, according to one embodiment.

FIG. 7 is a block diagram of an exemplary computer system used in accordance with various embodiments.

The drawings referred to in this description should be understood as not being drawn to scale except if specifically noted.

### DETAILED DESCRIPTION

Reference will now be made in detail to embodiments of the present technology for query spelling correction, examples of which are illustrated in the accompanying drawings. While the technology for query spelling correction will be described in conjunction with various embodiments, it will be understood that they are not intended to limit the present technology for query spelling correction to these embodiments. On the contrary, the presented technology for query spelling correction is intended to cover alternatives, modifications and equivalents, which may be included within the spirit and scope the various embodiments as defined by the appended claims. Furthermore, in the following detailed description, numerous specific details are set forth in order to provide a thorough understanding of the present technology for query spelling correction. However, the present technology for query spelling correction may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving,” “using,” “configuring,” “obtaining,” “determining,” “making,” “analyzing,” “providing,” “performing” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for query spelling correction is also well suited to the use of other computer systems such as, for example, optical and mechanical computers.

### Overview

According to one embodiment, web search results are used as a part of determining a correction candidate for an incorrectly spelt query term. First, web search results can be used as a part of determining whether a query term is correctly spelt. For example, navigational queries usually contain terms that are parts of destination URLs, which may contain out-of-vocabulary terms since there are millions of sites on the Internet. Inferring navigational queries through URL fragment matching can help reduce the probability that a query that includes a query term for an uncommon web site name, such as “innovet” would be incorrectly modified to a more commonly used word such as “innovate.” In another example, web search results can be used to identify acronyms. For example, assume that the query includes the query term “SCOPI” which is an acronym for an organization “Systeme de Communication et de Partage de Information™.” Traditional query spelling correction models would probably incorrectly modify “SCOPI” to “scope.” Frequently an acronym is specified in text using a text pattern where the full name of an organization is followed by the acronym of the organization in parenthesis. The incorrect modification of the acronym “SCOPI” can be prevented by analyzing web search results based on text patterns to identify acronyms.

Second, web search results can be used as a part of determining correction candidates for incorrectly spelt query terms. For example, terms associated with web search results provide information as to a user's intention. In a specific example, if a user incorrectly spelt a query term “vacuum” as “vaccum” there is a high probability that the web search results obtained from the incorrectly spelt query term “vaccum” will include the correctly spelt word “vacuum.”

### Queries and Query Values

A user may enter a query into a data entry field of a web page associated with a web search engine. The query may include one or more query terms. The query terms may be separated by blanks. The query terms may be, among other things, words or acronyms. The web search engine can access the query and search the network for information that satisfies the query. Examples of queries include “Vaccum cleaner,” “vacuum cleaner,” “Vaccum,” “Vacuum,” “scopi,” and so on. “Vaccum cleaner” and “Vacuum cleaner” are examples of queries that include more than one query terms.

### Web Search Results

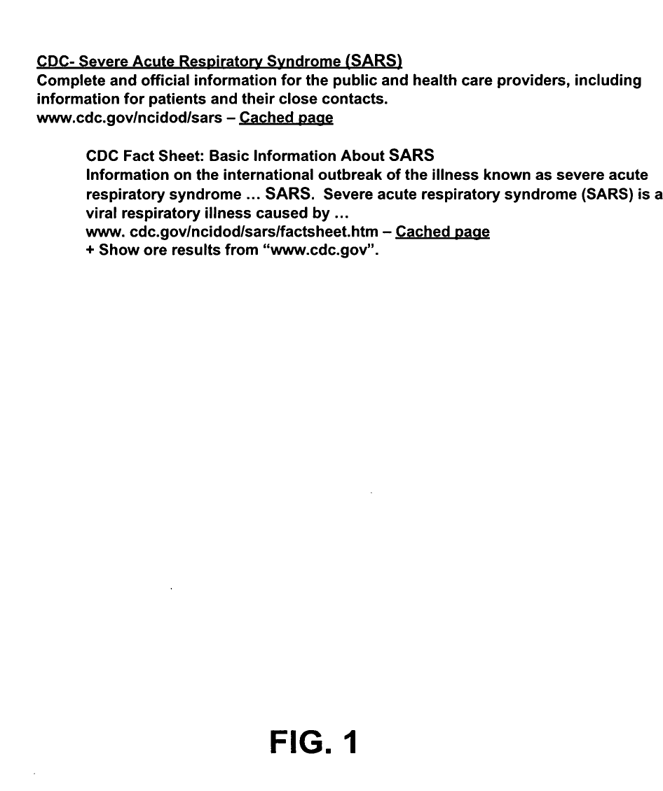

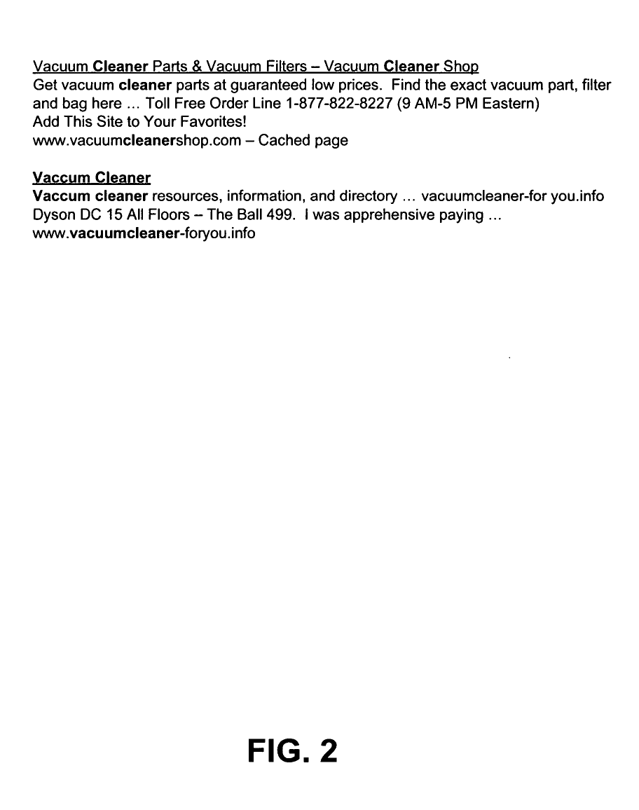

Web search results that depict for example one or more URLs to documents that satisfy the query are found by the web search engine. FIGS. 1 and 2 depict parts of web search results, according to various embodiments. FIG. 1 depicts part of web search results that resulted from the query term “SARS.” FIG. 2 depicts part of web search results that resulted from the query “vaccum cleaner” where the query includes the incorrect spelling “vaccum” for the word “vacuum.” Both FIG. 1 and FIG. 2 depict URLs such as “www.cdc.gov/ncidod/sars,” “www.cdc.gov/ncidod/sars/facatsheet.html,” “www.vacuumcleanershop.com,” and “www.vaccumcleaner-foryou.info.” The web search results associated with FIGS. 1 and 2 also include titles and snippets. For example, FIG. 2 includes the title “Vacuum Cleaner Parts & Vacuum Filters—Vacuum Cleaner Shop” and the snippet “Get vacuum cleaner parts at guaranteed low prices. Find the exact vacuum part, filter and bag here. . . . Toll Free Order Line 1-877-822-8227 (9AM-5PM Eastern).”

Web search results can be used to identify acronyms using for example text patterns, according to one embodiment. Referring to FIG. 1, SARS is an acronym for Severe Acute Respiratory Syndrome as indicated by the text pattern of the full name “Severe Acute Respiratory Syndrome” followed by the acronym enclosed in parentheses “(SARS).”

Terms associated with web search results provide information as to a user's intention, according to one embodiment. In a specific example, if a user incorrectly spelt a query term “vacuum” as “vaccum” there is a high probability that the web search results obtained from the incorrectly spelt query term “vaccum” will include the correctly spelt word “vacuum.” This can be attributed to the collective link text distribution on the Internet where many links with misspelled text point to sites with correctly spelt text. For example, although the web search results depicted in FIG. 2 were obtained based on an incorrectly spelt query term “vaccum,” the web search results include the correctly spelt “vacuum.”

Web search results typically include fewer web pages for incorrectly spelt query terms than for correctly spelt query terms. For example, approximately 1.5 million web pages may be returned for the incorrectly spelt query term “vaccum” and approximately 72 million web pages may be returned for the correctly spelt query term “vacuum.”

Web search results for a correctly spelt query term such as “vacuum” and an incorrectly spelt version such as “vaccum” typically include similar context information. For example, the web search results for “vacuum” and “vaccum” may both include terms such as “cleaner,” “pump,” “bag,” or “systems.” The similar context of the web pages returned for searches performed using “vacuum” and “vaccum” can be used to indicate that “vaccum” is an incorrect spelling of “vacuum.”

As will become more evident acronyms, context, number of terms associated with web search results are just a few features that can be used as a part of query spelling correction.

### Problem Statement

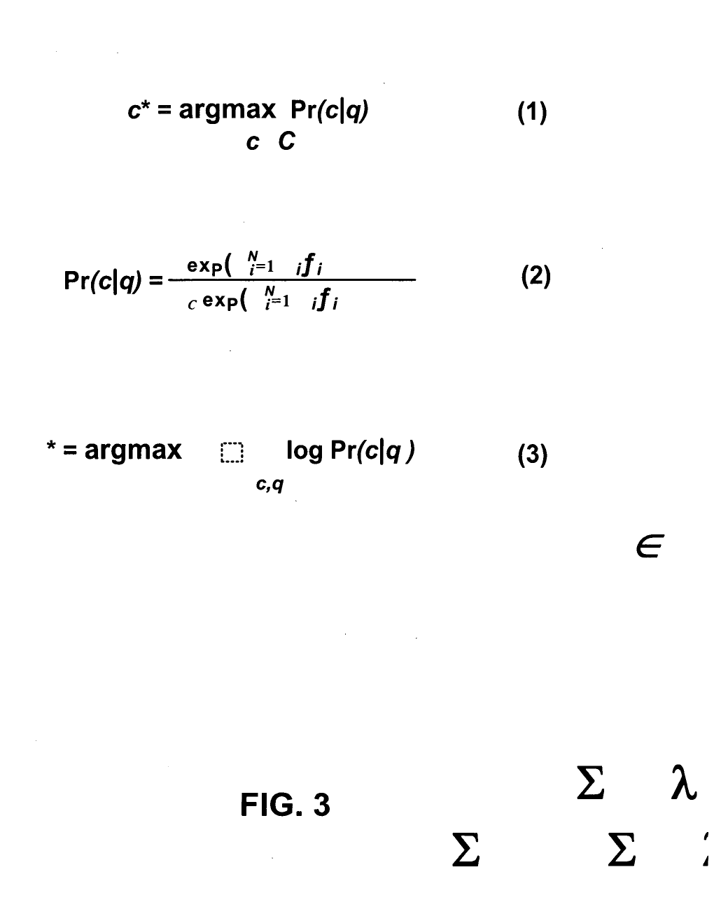

FIG. 3 depicts equations, according to various embodiments. Equation 1 is used to express a statement of a problem involved in query spelling correction, according to one embodiment. For example, given a user specified query q, a correction candidate c, which is a query string, is found that maximizes the posterior probability Pτ(c|q) of c given q within a confusion set C of q. A confusion set C includes various possible correction candidates c to a query q, as will become more evident. Each correction candidate c associated with the confusion set C is a correction candidate for q, which satisfies the constraint that the spelling similarity between c and q is within a threshold δ. The query q belongs to its confusion set C. When a more probable correction candidate c in C, which is different from a query term from q under consideration, is identified a spelling error has occurred and a correction candidate c is suggested.

### Maximum Entropy Model

A maximum entropy model is used to model the conditional probability Pτ(c|q) (also known as a “posterior probability”) associated with equation 1 (FIG. 3), according to one embodiment. The maximum entropy model is a feature based model of class distribution to describe a probabilistic distribution, according to one embodiment. For example, a maximum entropy model can be used to describe the possibility that an event will occur based on pieces of evidence by estimating the probabilistic distribution of the pieces of evidence. In a specific example, an event may be whether it will rain tomorrow and the pieces of evidence may be the type of clouds, the number of clouds, the level of humidity and so on. A type of evidence, according to one embodiment, shall be referred to as a feature. A feature may be implemented as a variable in a software program. Values for features (referred to herein as “feature values”) can be obtained from various sources. For example, feature values can be obtained from a lexicon, query logs, or web search results, among other things. The maximum entropy model provides a natural way and unified framework for integrating various available sources of information, such as lexicons, query logs, and web search results.

Equation 2 (FIG. 3) depicts an equation that can be used for deriving the posterior probability Pτ(c|q) based on an equation for a maximum entropy model, according to one embodiment. For example, referring to equation 2, the denominator

$${\sum }_{c} exp ( {\sum }_{i = 1}^{n} λ ifi ( c , q ) )$$

is a normalization factor and ƒi(c,q) is a feature function defined over query q and correction candidate c. n is the total number of features and λi is the corresponding feature weight. Feature weights can be optimized by maximizing the posterior probability on a training set by selecting the λᵢ that maximizes the log probability of the correct query given the incorrect query, for example, across the entire training set. λs can be optimized using numerical optimization algorithms such as the Generalized Iterative Scaling (GIS) algorithm by maximizing the posterior probability of the training set which contains, for example, manually labeled set of query-truth pairs as expressed by equation 3 (FIG. 3).

### Confusion Set and Training

There are various possible ways of interpreting one or more query terms associated with a query. The various possible ways of interpreting a user specified query q may be referred to as a confusion set C, according to one embodiment. An implementation of a maximum entropy model can be trained using a subset of a confusion set C. A correction candidate c is a query string that is one possible way of interpreting all or part of the user specified query q, according to one embodiment. The correction candidate c may be selected from the confusion set C.

According to one embodiment, correction candidates associated with a confusion set are generated for each query term associated with a query from a term extracted from a source, such as query logs or web search results. Continuing the example, in this case a query may be “vacccum cleaner,” the query term may be “vaccum” and the correction candidate may be “vacuum,” which is extracted from a source such as a query log or web search results. Various spelling correction methods such as generating correction candidates based on edit distance or phonetic similarity can be used. According to one embodiment, the relative proximity of two characters on a standard QWERTY keyboard layout is used as a part of determining edit distance. Phonetic similarity can be determined using a text-to-phoneme converter or by retrieving a phonetic description from a lexicon, for example. The correction candidates for an entire query can be generated by composing the correction candidates of each individual query term. For example, assume that q=w₁ . . . wₙ, and that the confusion set of wᵢ is C_{wi}, then according to one embodiment the confusion set of q is C_{w1}\textcircled{×}C_{w2}\textcircled{×} . . . C_{wn}. More specifically, for a query q that equals w₁ w₂, assume that w₁ has candidates c₁₁ and c₁₂ and w₂ has candidates c₂₁ and c₂₂, then the confusion set C is {c₁₁c₂₁,c₁₁c₂₂,c₁₂c₂₁,c₁₂c₂₂}, according to one embodiment. For simplicity, compound and composite errors were not denoted in C_{w1}\textcircled{×}C_{w2}\textcircled{×} . . . C_{wn}.

A confusion set can be pruned, for example, by roughly ranking the candidates based on the statistical n-gram language model estimated from a source, such as query logs. A subset of the confusion set C that results for example from the pruning and that contains for example a specified number of top-ranked (most probable) candidates can be used for offline training of an implementation of the maximum entropy model or for online re-ranking, or a combination thereof. The number of correction candidates can be used as a parameter to balance top-line performance and run-time efficiency.

### Features

A maximum entropy model can be used to describe the possibility that an event will occur based on pieces of evidence by estimating the probabilistic distribution of the pieces of evidence, according to one embodiment. A type of evidence can be thought of as a feature. A feature may be implemented as a variable in a software program. Values for features (referred to herein as “feature values”) can be obtained from various sources. For example, feature values can be obtained from a lexicon, query logs, or web search results, as will become more evident. A maximum entropy model can be configured using the feature values.

The following is a list of features (also referred to as “initial features”), according to one embodiment. Values for initial features can be obtained, for example, from a lexicon or a query log.
a language model feature based on the logarithm language model probability of the candidate word sequence;
edit distance features, based on the edit distance between correction candidates and input query terms;
input frequency features, based on the frequency of input query terms in the query logs;
candidate frequency features, based on the frequency of correction candidates in the query logs;
input lexicon features, based on whether input query terms appear in a lexicon;
candidate lexicon features, based on whether correction candidates appear in the lexicon;
phonetic features, based on the distance between the phonetic description of a query term and the phonetic description of a correction candidate;
distributional similarity based query term features, based on a combination of distributional similarity and the frequencies of correction candidates and query terms; and
distributional similarity based correction candidate features, based on a combination of distributional similarity, the frequencies of correction candidates and query terms, and whether a correction candidate is in a lexicon.

The following is a list of features (referred to herein as “web search report features”), according to one embodiment. Values for web search report features can be obtained, for example, from a web search report.
the number of pages associated with web search results for a user specified query q;
the frequency of URL fragments that match query terms associated with the user specified query q, for example, associated with the top documents from a web search report. For example, referring to FIG. 1, “cdc” is a URL fragment of the URL “www.cdc.gov/ncidod/sars;”
the frequency that a query term occurs in web search results. For example, the number of times that a query term occurs in titles or snippet text of the top documents associated with a web search report;
the frequency that a potential correction candidate that is being considered for a query term occurs in web search results. For example, the number of times that a potential correction candidate that is being considered occurs in titles or snippet text of the top documents associated with a web search report can be used to determine whether to use the potential correction candidate as a correction candidate; and
an indication that a query term is an abbreviation. For example, web search results can be analyzed using text patterns to determine whether a query term from a query is an abbreviation. An indication of true or false, for example, can be returned indicating whether an abbreviation that matches the query term was found in the web search results.

The feature values depend, according to one embodiment, on factors such as what the features are, initial features or web search report features for example, what query was used, what sources the feature values were obtained from and so on.

### Configuring a Maximum Entropy Model with Feature Values

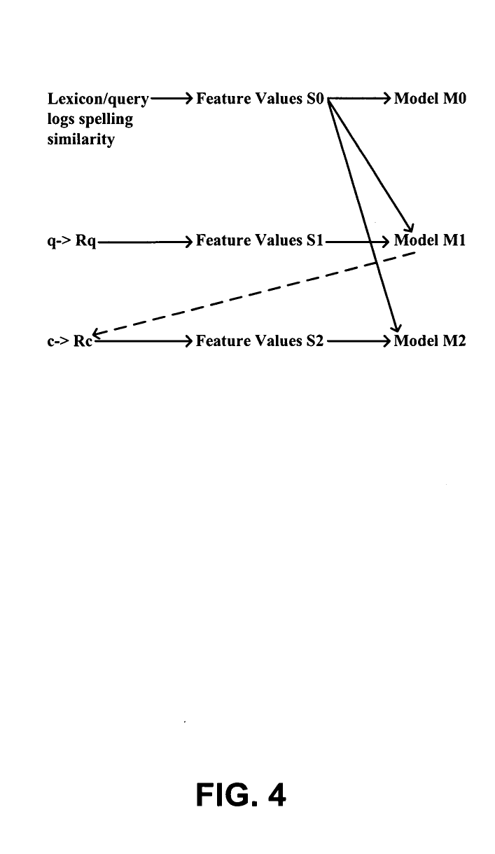

According to one embodiment, a maximum entropy model can be configured with feature sets (also referred to herein as feature values). FIG. 4 depicts a relationship between different configurations of a maximum entropy model based on different feature sets, according to one embodiment. For example, feature set S0 is for initial features obtained from a lexicon or a query log, or a combination thereof. Features set S1 is for web search result features obtained from web search results Rq that resulted from a web search performed using a query q. Feature set S2 is for web search result features obtained from web search results Rc that resulted from a web search performed using a correction candidate c. The dotted line from model M1 to correction candidate c indicates that correction candidate c is a correction candidate for query q. Feature set S0 can be used to configure a maximum entropy model resulting in model M0. Feature set S1 or a combination of feature sets S0 and S1 can be used to configure a maximum entropy model resulting in model M1. Feature set S2, a combination of feature sets S1 and S2, or a combination of feature sets S0, S1 and S2 can be used to configure a maximum entropy model resulting in model M2.

Various features can be used by a maximum entropy model to determine a set of one or more correction candidates. To illustrate, assume that a user specified the incorrectly spelt query term “vaccum” and the correction candidate “vacuum” is suggested. However, the system does not know whether “vacuum” is correct. For example, referring to FIG. 4, a query q that includes the incorrectly spelt query term “vaccum” is received by a web search engine. The web search engine returns web search results Rq based on the incorrectly spelt “vaccum.” Feature values S1 are obtained from web search results Rq. According to one embodiment, the feature values S1 are values for web search result features. Feature values S1 are used to configure a maximum entropy model resulting in model M1. M1 is used to obtain a correction candidate c, “vacuum,” based on the feature values S1.

### Top Ranked Correction Candidate

The correction candidates are ranked according to one embodiment to determine one or more top ranked correction candidates, according to one embodiment. Continuing the example of an incorrectly spelt query term “vaccum” and the suggested correction candidate “vacuum,” the system may not be able to determine based on model M1 whether “vacuum” is correct. So according to one embodiment, the correction candidate(s) are ranked. For example, the correction candidate c, which in this illustration would be the correctly spelt “vacuum,” is processed by the web search engine to obtain second web search results Rc.

Feature set S2 is obtained from the web search results Rc. The feature set S2 is for web search result features. Feature set S2 is generated for each candidate based on Rc. The feature set S2 contains feature values pertaining to document similarities between Rq and Rc, according to one embodiment. For example, cosine measurements based on query term frequency vectors of Rq and Rc can be used to generate feature values S2. Feature set S2 can be used to configure the maximum entropy model resulting in model M2. M2 may be used to re-rank the candidates.

### A System for Query Spelling Correction

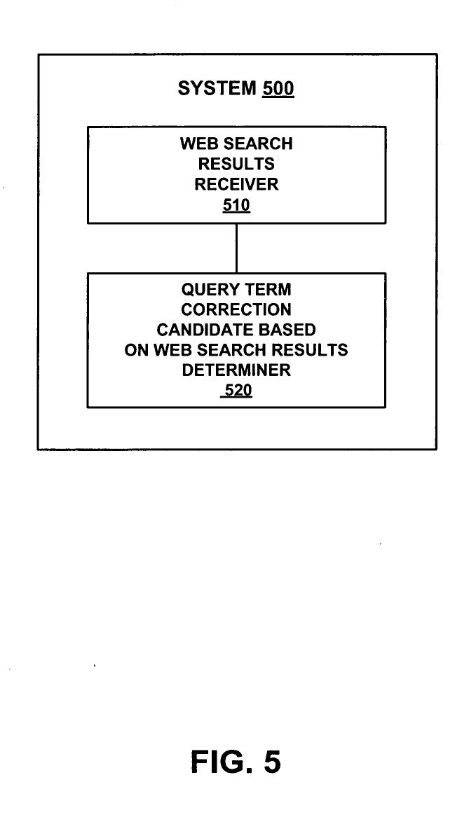

FIG. 5 is a block diagram of a system 500 for query spelling correction, according to one embodiment. The blocks that represent features in FIG. 5 can be arranged differently than as illustrated, and can implement additional or fewer features than what are described herein. Further, the features represented by the blocks in FIG. 5 can be combined in various ways. The system 500 can be implemented using software, hardware, firmware, or a combination thereof.

As depicted in FIG. 5, the system 500 includes a web-search-results-receiver 510 (referred to hereinafter as “a receiver”) and a query-term-correction-candidate-based-on-web-search-results-determiner 520 (referred to hereinafter as “a determiner”). The receiver 510 is configured for receiving web search results generated based on a query term. For example, the receiver 510 can receive web search results Rq and Rc, as described herein. The determiner 520 is configured for using the web search results to determine a correction candidate for the query term if the query term is spelt incorrectly. For example, the determiner 520 may include an implementation of a maximum entropy model that can be configured with feature values. The determiner 520 can be configured with feature values S0, S1, or S2 or a combination thereof resulting in models M0, M1 or M2, or a combination thereof. The receiver 510 is coupled to the determiner 520.

### A Method of Query Spelling Correction

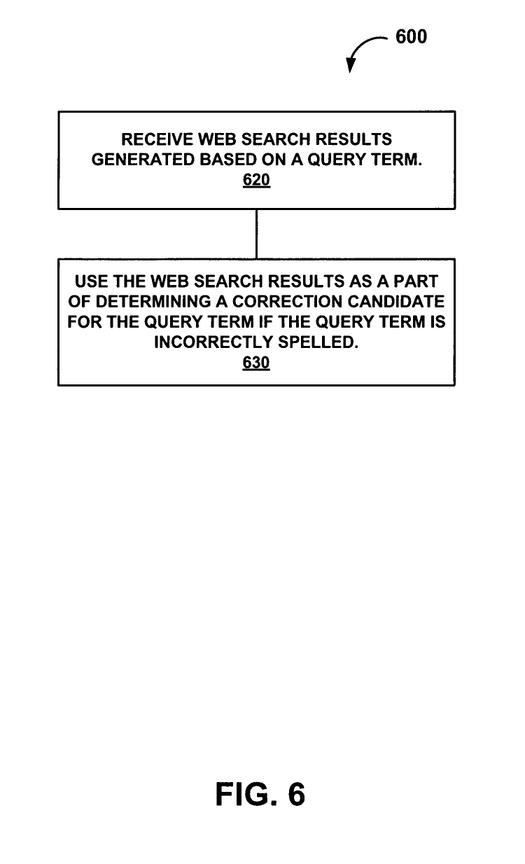

FIG. 6 is a flowchart 600 of a method of query spelling correction, according to one embodiment. Although specific steps are disclosed in flowchart 600, such steps are exemplary. That is, various embodiments are well suited to performing various other steps or variations of the steps recited in flowchart 600. It is appreciated that the steps in flowchart 600 may be performed in an order different than presented, and that not all of the steps in flowchart 600 may be performed.

All of, or a portion of, the embodiments described by flowchart 600 can be implemented using computer-readable and computer-readable program code (also known as “instructions”) which reside, for example, in computer-usable media of a computer system or like device. The computer-usable media can be any kind of memory that instructions can be stored on. Examples of the computer-usable media include but are not limited to a disk, a compact disk (CD), a digital video device (DVD), read only memory (ROM), flash, and so on. As described above, certain processes and steps are realized, in one embodiment, as a series of instructions (e.g., software program) that reside within computer readable memory of a computer system and are executed by the processor of the computer system. When executed, the instructions cause the computer system to implement the functionality of various embodiments as described below.

In preparation of the flowchart 600, assume that queries that were received at a web search engine may be stored in a query log and that feature values S0 for one or more initial features were obtained from a lexicon or a query log, or a combination thereof. Various initial features are described, among other places, in the “Features” section.

At 620, web search results generated based on a query term are received. For example, a user specified query q (FIG. 4) that includes the incorrectly spelt “vaccum” is received by a web search engine. The web search engine returns web search results Rq (FIG. 4). The receiver 510 (FIG. 5) receives the web search results Rq.

At 630, the web search results are used as a part of determining a correction candidate for the query term if the query term is incorrectly spelt. For example, feature values S1 (FIG. 4) are obtained from web search results Rq (FIG. 4). According to one embodiment, the feature values S1 are values for web search result features. Various web search results features are described in the “Features” section. Feature values S0 and S1 are received or determined by the determiner 520 (FIG. 5).

The feature values S0 and S1 are used to configure a maximum entropy model associated with the determiner 520 resulting in model M1, according to one embodiment. The feature values S1 may be obtained for features such as a number of pages, URL fragments and so on associated with the web search results Rq. For example, the number of pages for the incorrectly spelt “vaccum” would be fewer than the number of pages for the correctly spelt “vacuum” which can be used as an indication of what the correct spelling is. In another example, the number of times that the query term or the correction candidate occur in the web search results Rq can be used as a part of determining whether a query term is misspelt or whether a correction candidate under consideration should be made a correction candidate. For example, the number of times that the correction candidate “vacuum” occurs in web search results Rq would probably far exceed the number of times that the query term “vaccum” occurs in the web search results Rq. Further, the web search results for both “vaccum” and “vacuum” would probably include similar content such as “cleaner,” “bags,” and so on further indicating that “vaccum” and “vacuum” are potentially the same word. The feature values S1 may include a URL fragment from the web search results Rq that can be used to determine if a query term is incorrectly spelt. For example, if the query term were “SCOPI” and the web search results Rq included a URL for the organization “Systeme de Communication et de Partage de Information™” with a URL fragment “SCOPI” the determiner 520 would be able to use the URL fragment to determine that “SCOPI” is correctly spelt and not modify “SCOPI” to “scope.”

M1 (FIG. 4) is used to obtain a correction candidate c (FIG. 4) “vacuum”. If a correction candidate c is returned, the determiner 520 (FIG. 5) knows that the query term “vaccum” was incorrect, according to one embodiment.

According to one embodiment, a top ranked correction candidate is determined based on the correction candidate c. For example, the correction candidate c, which in this illustration would be the correctly spelt “vacuum,” is processed by the web search engine to obtain second web search results such as web search results Rc. Feature values S2 are obtained from the second web search. The feature values S2 may be for one or more web search results features which are described, among other places, in the “Features” section. Feature values S2 can be received or determined by the determiner 520 and are used to configure the maximum entropy model associated with the determiner 520 resulting in model M2. Any of the features that values were obtained for S1 could also be used for S2, according to one embodiment. M2 may be used to re-rank correction candidates.

### An Example of a Computer System Environment

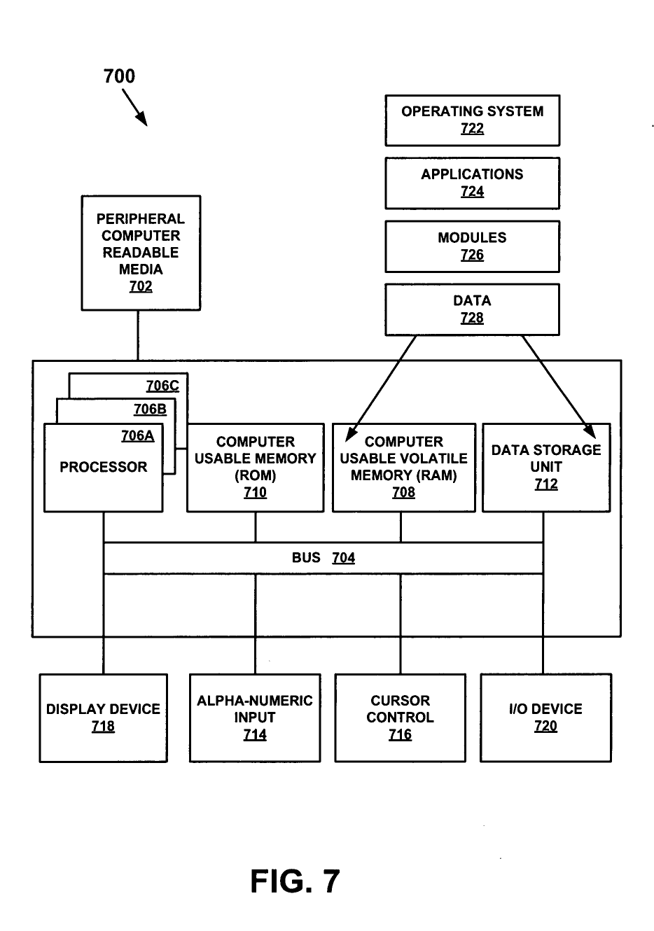

With reference now to FIG. 7, portions of the technology for query spelling correction are composed of computer-readable and computer-executable instructions that reside, for example, in computer-usable media of a computer system. That is, FIG. 7 illustrates one example of a type of computer that can be used to implement embodiments, which are discussed herein, of the present technology for query spelling correction. FIG. 7 is a block diagram of an exemplary computer system 700 used in accordance with various embodiments of the present technology for query spelling correction. It is appreciated that system 700 of FIG. 7 is exemplary only and that the present technology for query spelling correction can operate on or within a number of different computer systems including general purpose networked computer systems, embedded computer systems, routers, switches, server devices, client devices, various intermediate devices/nodes, stand alone computer systems, and the like. As shown in FIG. 7, computer system 700 of FIG. 7 is well adapted to having peripheral computer readable media 702 such as, for example, a floppy disk, a compact disc, and the like coupled thereto.

System 700 of FIG. 7 includes an address/data bus 704 for communicating information, and a processor 706A coupled to bus 704 for processing information and instructions. As depicted in FIG. 7, system 700 is also well suited to a multiprocessor environment in which a plurality of processors 706A, 706B, and 706C are present. Conversely, system 700 is also well suited to having a single processor such as, for example, processor 706A. Processors 706A, 706B, and 706C may be any of various types of microprocessors. System 700 also includes data storage features such as a computer usable volatile memory 708, e.g. random access memory (RAM), coupled to bus 704 for storing information and instructions for processors 706A, 706B, and 706C. System 700 also includes computer usable non-volatile memory 710, e.g. read only memory (ROM), coupled to bus 704 for storing static information and instructions for processors 706A, 706B, and 706C. Also present in system 700 is a data storage unit 712 (e.g., a magnetic or optical disk and disk drive) coupled to bus 704 for storing information and instructions. System 700 also includes an optional alphanumeric input device 714 including alphanumeric and function keys coupled to bus 704 for communicating information and command selections to processor 706A or processors 706A, 706B, and 706C. System 700 also includes an optional cursor control device 716 coupled to bus 704 for communicating user input information and command selections to processor 706A or processors 706A, 706B, and 706C. System 700 of the present embodiment also includes an optional display device 718 coupled to bus 704 for displaying information.

Referring still to FIG. 7, optional display device 718 of FIG. 7 may be a liquid crystal device, cathode ray tube, plasma display device or other display device suitable for creating graphic images and alphanumeric characters recognizable to a user. Optional cursor control device 716 allows the computer user to dynamically signal the movement of a visible symbol (cursor) on a display screen of display device 718. Many implementations of cursor control device 716 are known in the art including a trackball, mouse, touch pad, joystick or special keys on alpha-numeric input device 714 capable of signaling movement of a given direction or manner of displacement. Alternatively, it will be appreciated that a cursor can be directed and/or activated via input from alpha-numeric input device 714 using special keys and key sequence commands. System 700 is also well suited to having a cursor directed by other means such as, for example, voice commands. System 700 also includes an I/O device 720 for coupling system 700 with external entities. For example, in one embodiment, I/O device 720 is a modem for enabling wired or wireless communications between system 700 and an external network such as, but not limited to, the Internet.

Referring still to FIG. 7, various other components are depicted for system 700. Specifically, when present, an operating system 722, applications 724, modules 726, and data 728 are shown as typically residing in one or some combination of computer usable volatile memory 708, e.g. random access memory (RAM), and data storage unit 712. In one embodiment, the present technology for query spelling correction, for example, is stored as an application 724 or module 726 in memory locations within computer usable volatile memory 708 and memory areas within data storage unit 712.

The computer-readable and computer-executable instructions reside, for example, in data storage features such as computer usable volatile memory 708, computer usable non-volatile memory 710, and/or data storage unit 712 of FIG. 7. The computer-readable and computer-executable instructions are used to control or operate in conjunction with, for example, processor 706A and/or processors 706A, 706B, and 706C of FIG. 7.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of query spelling correction, the method comprising:
receiving web search results generated based on a query term; and
using the web search results as a part of determining a correction candidate for the query term if the query term is incorrectly spelt.

2. The method as recited by claim 1, wherein the using of the web search results as a part of determining the correction candidate further comprises:
using a maximum entropy model as a part of determining the correction candidate.

3. The method as recited by claim 2, further comprising:
configuring the maximum entropy model with feature values obtained from the web search results.

4. The method as recited by claim 1, further comprising:
obtaining second web search results using the correction candidate; and
determining at least one top ranked correction candidate using the second web search results.

5. The method as recited by claim 4, further comprising:
configuring a maximum entropy model with feature values obtained from the second web search results and using the maximum entropy model as a part of determining the top ranked correction candidate.

6. The method as recited by claim 1, wherein the using of the web search results as a part of determining the correction candidate further comprises:
using a number of pages associated with the web search results as a part of determining the correction candidate.

7. The method as recited by claim 1, wherein the using of the web search results as a part of determining the correction candidate further comprises:
using a URL fragment associated with the web search results as a part of determining if the query term is incorrectly spelt.

8. A system for query spelling correction, the system comprising:
a web-search-results-receiver configured for receiving web search results generated based on a query term; and
a query-term-correction-candidate-based-on-web-search-results-determiner configured for using the web search results to determine a correction candidate for the query term if the query term is spelt incorrectly, wherein the web-search-results-receiver is coupled to the potential-correction-to-misspelt-query-term-based-on-web-search-results-determiner.

9. The system of claim 8, wherein a maximum entropy model is associated with the query-term-correction-candidate-based-on-web-search-results-determiner and wherein the maximum entropy model is used as a part of determining the correction candidate.

10. The system of claim 8, wherein the query-term-correction-candidate-based-on-web-search-results-determiner is configured with feature values obtained from the web search results.

11. The system of claim 8, wherein the query-term-correction-candidate-based-on-web-search-results-determiner is used to determine at least one top ranked correction candidate after being configured with feature values obtained from second web search results, wherein the second web search results were obtained based on the correction candidate.

12. The system of claim 8, wherein the query-term-correction-candidate-based-on-web-search-results-determiner uses a number of times that a potential correction candidate occurs in the web search results as a part of determining whether to make the potential correction candidate the correction candidate.

13. The system of claim 8, wherein the query-term-correction-candidate-based-on-web-search-results-determiner uses a number of times that the query term occurs in the web search results as a part of determining the correction candidate.

14. The system of claim 8, wherein the query-term-correction-candidate-based-on-web-search-results-determiner analyzes the web search results based on a text pattern to determine whether the query term is an abbreviation.

15. Instructions on a computer-usable medium wherein the instructions when executed cause a computer system to perform a method of query spelling correction, the method comprising:
storing queries that were received at a web search engine in a query log;
receiving web search results generated based on a query term; and
using the web search results and the query log as a part of determining a correction candidate for the query term if the query term is incorrectly spelt.

16. The instructions of the computer-usable medium of claim 15, wherein the computer-readable program code embodied therein causes a computer system to perform the method, and wherein the using of the web search results and the query log as a part of determining the correction candidate further comprises:
using a maximum entropy model as a part of determining the correction candidate.

17. The instructions of the computer-usable medium of claim 16, wherein the computer-readable program code embodied therein causes a computer system to perform the method, and wherein the method further comprises:
configuring the maximum entropy model with feature values obtained from one or more web search results.

18. The instructions of the computer-usable medium of claim 15, wherein the computer-readable program code embodied therein causes a computer system to perform the method, and wherein the method further comprises:
obtaining second web search results using the correction candidate; and
determining at least one top ranked correction candidate using the second web search results.

19. The instructions of the computer-usable medium of claim 15, wherein the computer-readable program code embodied therein causes a computer system to perform the method, and wherein the using of the web search results and the query log as a part of determining the correction candidate further comprises:
analyzing the web search results based on a text pattern to determine whether the query term is an abbreviation.

20. The instructions of the computer-usable medium of claim 15, wherein the computer-readable program code embodied therein causes a computer system to perform the method, and wherein the using of the web search results and the query log as a part of determining the correction candidate further comprises:
using a URL fragment associated with the web search results as a part of determining if the query term is incorrectly spelt.
